(19) United States
(12) Patent Application Publication
(10) Pub. No.: US 2011/0044470 A1
(43) Pub. Date: Feb. 24, 2011

(54) ARTIFICIAL ENGINE SOUND GENERATOR

(76) Inventor: Ryoichi OGATA, Zushi-city (JP)

Correspondence Address: SMITH PATENT OFFICE, 1901 PENNSYLVANIA AVENUE N W, SUITE 901, WASHINGTON, DC, 20006, US

(21) Appl. No.: 12/765,422

(22) Filed: Apr. 22, 2010

(30) Foreign Application Priority Data
Aug. 21, 2009 (JP) 2009-211058

(51) Int. Cl. H04B 1/00

(52) U.S. Cl. 381/86

(57) ABSTRACT

To solve the safety problem of electric and hybrid vehicles, the engine sound of these vehicles is too quiet, so the pedestrians cannot recognize the approaching vehicles. In order to solve the problem, equip the electric motored vehicle with the artificial engine sound generator, which emits a sound similar to a gasoline engine. This is set up with the CAN-module unit, which can be connected to the CAN-bus communication of the on-board electric devices. This unit is composed of the CAN-module and the sound module, which output the sound, based on the control signals from the CAN-module. The CAN-module receives the signals from the detecting device of the driving environment and controls the audio output device (the Speaker), which is connected to the sound module, and outputs the artificial sound.

### TECHNICAL FIELD

This invention relates to an artificial engine sound generator. It is the on-board device for the electric motor-driven vehicles, whose engine sound and driving sound is very quiet: electric and hybrid vehicles including buses and trucks, electric motorcycles, electric cart, electric bicycle, and regular human-powered bicycle, which emits an artificial engine sound when needed,

### BACKGROUND ART

Since the engine sound of the electric vehicles and hybrid vehicles are very quiet when they are starting, moving slowly or reversing, people do not recognize the approaching vehicle, and safety concerns have been raised. Even if the drivers are paying attention, the pedestrians and cyclists do not recognize the approaching vehicle, especially when the vehicle is parking, making a U-turn, or driving on a very narrow commercial street.

Various measures have been taken to solve these problems: speakers are equipped to the vehicle and the speakers emit an artificial noise mimicking a gas-powered engine or specific melody.

In the conventional systems, a current detector is installed between an electric motor and a battery, a mobility detector is installed on the moving part of the accelerator, or a rotational frequency detector is installed on rotational part of vehicle. Depending on these, the speakers which connected to the artificial sound controller emit the artificial engine sound. (e.g. refer to Patent document 1)

### [Prior Art Document]

### [Patent Document]

[Patent Document 1] TOKKAI #2000-316201 Patent Bulletin

### SUMMARY OF INVENTION

The above-mentioned conventional systems simply emit the artificial engine sound by detecting the vehicle's travel motion by installing a detector on the specific part of the vehicle. These systems can let the pedestrians know that the vehicle is approaching, however, to install the detector is a costly alternative, and its artificial sound is not responding to the speed of the vehicle, so it does not provide the reality of the sound quality, thus the conventional systems should be improved so that it can emit more realistic artificial sound when needed.

When vehicle is driving on the local street or highway where a lot of vehicles are driving, to emit the artificial sound is unnecessary, same as when the vehicle is traveling on the road of suburb with a good view, and when the vehicle is driving at night with the head lights on. Furthermore, the system does not turn up the volume according to the ambient environment, for example when it is raining very hard.

Therefore the artificial engine sound generator is required to control the variety and volume of the artificial sound according to the driving condition such as speed and the ambient environment such as driving location for the super-quiet vehicles.

In order to satisfy these requirements, the artificial engine sound should be controlled by integrated control system with collected information from various detectors installed in different part of the vehicles and from other information sources, however, this presents some problems.

That is, when only wiring detectors, the integrated control system and the artificial engine sound generator, the number of the detective device and wiring will be large, so the risk of improper connection will arise, the cost of the installation will be high and the wiring operation will be complicated. These problems also should be dealt with.

Also, there is the artificial engine noise generator with the simple ON/OFF switch on the market. However, this type of device has pragmatic problems; it could induce inattentive driving by operating the device while driving, and there is possibility of operational error and of forgetting to turning off the sound.

The other sound generator, which generates the sound of the centrifugal force by being connected to the wheel was developed, however, ordinary people do not sense the danger by its sound without thinking, and it has problems such as ageing failure, puncture, burst or falling caused by unexpected occurrence hitting curbside.

This invention had been done with view of the above situations, and its purpose is to solve the safety problems; when a hybrid vehicle is driven with electric motor, it moves so quietly without engine sound that the pedestrians do not recognize that the vehicle is approaching because they do not hear the moving noise of the vehicle, by inventing the safe Artificial Engine Sound Generator which assess the surrounding environment of the moving vehicle and appropriately generates the artificial engine sound with which ordinary people can recognize the danger without fault, with simple component and easy installation.

### [Means of Solving the Problems]

In order to achieve the object, the Artificial Engine Sound Generator of this invention (of Claim 1 of this invention) is equipped with the device, which generates the artificial engine sound of the gas-powered vehicle detecting the driving environment of the vehicle on the electric vehicles. This device is composed of CAN-bus Communication Part of the vehicle and the cascadable CAN-module Unit. Pairing the CAN-module, which is wired to the vehicle CAN-bus, and the sound module, which makes the sound in accordance with the controlling signals from the CAN-module, composes this CAN-module Unit. This CAN-module receives the signals from the various detectors, which detect the driving environment (basically through 1 or 2 wires), and controls the audio output device, which is wired to the sound module, and then this component makes the artificial engine sound.

The Artificial Engine Sound Generator of this invention (of Claim 2 of this invention) is the Artificial Engine Sound Generator of Claim 1, characterized by the items of the driving environments which should be input to the CAN-module are; the rotation frequency of the engine, the velocity of the vehicle, the degree of the stamping on the accelerator, the electric current between the electric motor and battery, the degree of the stepping on the brake, the ON/OFF of the headlight, the operating condition of the ignition, the position of the gearshift and other information necessary to each vehicle.

The Artificial Engine Sound Generator of this invention (of Claim 3 of this invention) is the Artificial Engine Sound Generator of Claim 1 or Claim 2, characterized by the above mentioned CAN-module being equipped with the CAN-Input Part, which input CAN-Communication Signals sent from the CAN-bus Communication Part, and the Analog Input Part which receives the analog signals sent by various equipment of the vehicles, and the CAN-module assess the driving condition by the CAN Communication Signals or by the combination of the CAN Communication Signals and the Analog Communication Signals, and obtains the control signal to the Sound Module.

The Artificial Engine Sound Generator of this invention (of Claim 4 of this invention) is the Artificial Engine Sound Generator of Claim 1, Claim 2 or Claim 3, characterized by the said CAN-Input Part is set to obtain the information of the start/stop of the engine, the motion of the various sensors, the velocity of the vehicle, the position of the gearshift and other data from the CAN-bus communication, and the above mentioned CAN-Output Part is equipped with the function, which sends the direction to generate the sound to the Sound Module by the CAN Signals.

The Artificial Engine Sound Generator of this invention (of Claim 5 of this invention) is the Artificial Engine Sound Generator of Claim 1, Claim 2, Claim 3 or Claim 4, characterized by the above mentioned sound module is equipped with the memory medium, which stores the various artificial engine sound.

The Artificial Engine Sound Generator of this invention (of Claim 6 of this invention) is the Artificial Engine Sound Generator of Claim 1, Claim 2, Claim 3, Claim 4 or Claim 5, characterized by above mentioned sound module is programmed to output the sound controlled by the signals from CAN-module by choosing any sound from various artificial sound stored in the memory medium.

The Artificial Engine Sound Generator of this invention (of Claim 7 of this invention) is the Artificial Engine Sound Generator of Claim 1, Claim 2, Claim 3, Claim 4, Claim 5 or Claim 6, characterized by the above mentioned memory medium can be selectively loaded with the various artificial engine sound or modify the memories by computer communication.

### [Advantage of the Invention]

As explained above, the Artificial Engine Sound Generator of this invention generates the appropriate artificial sound from the Sound Output Medium, which equipped to the Sound Module, adopting the CAN-module Unit, which combine the CAN-module and the Sound Module, in spite of its simple component, it can generate the appropriate artificial engine sound depending on the situation on electric vehicles and it is very effective to improve traffic safety.

By means of this invention, the can-module Unit is designed to receive signals from various detective devices and controls the artificial engine sound from the Sound Generating Media, so its component is simple, its installation is easy and makes the wiring of the vehicle efficient.

The alerting artificial sound, which is output from the Sound Module, can be either the artificial engine sound or alerting voice message.

The CAN-module Unit, which is the Artificial Engine Sound Generator of this invention, can be equipped as optional parts to the vehicle, or can be installed in the manufacturing process of the vehicle.

### BRIEF DESCRIPTION OF DRAWINGS

FIG. 1 The figure shows embodiment of the Artificial Engine Sound Generator of this invention. It is the outline drawing to explain the skeleton framework of the whole component, which includes the CAN-module Unit.

### BEST MODE FOR CARRYING OUT THE INVENTION

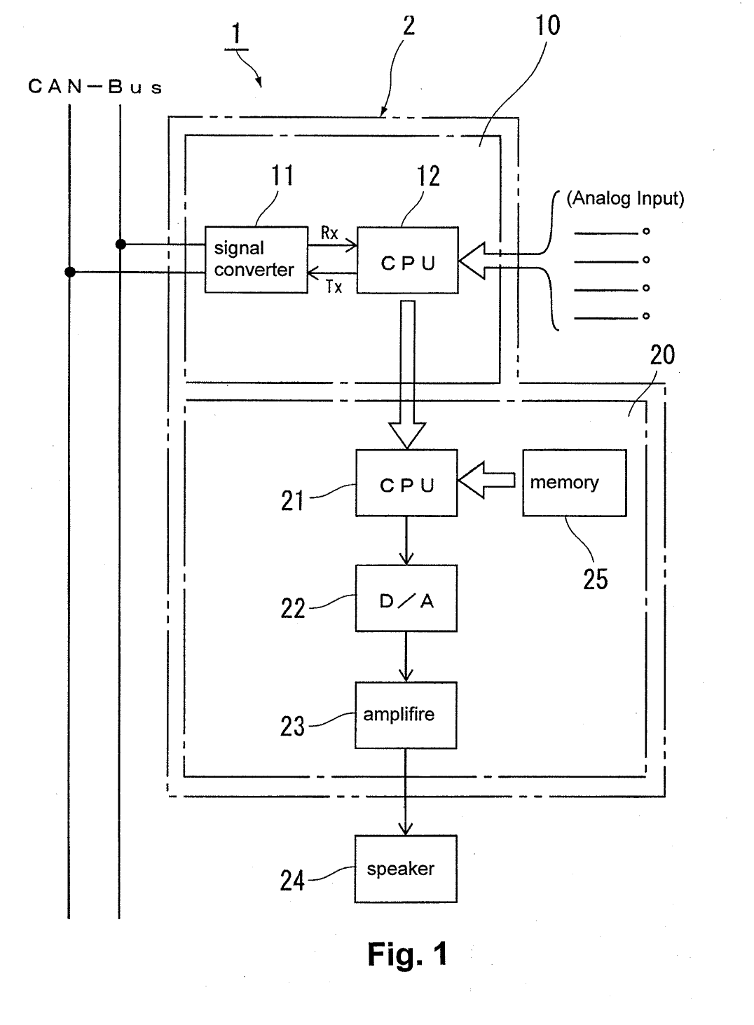

FIG. 1 shows an embodiment of the Artificial Engine Sound Generator of this invention. The Artificial Engine Sound Generator showed in Note 1 is the device that generates the artificial engine sound by detecting the driving environment of the vehicle. This equipment 1 is composed of Can-module 10, which is wired to the CAN-bus, and of the Sound Module 20, which send the sound output signal based on the control signal from the CAN-module 10, and by integrally pairing these two modules, the CAN-module Unit 2 is composed. This CAN-module Unit 2 functions as a device to generate the artificial engine sound as described below.

The CAN-module 10 is built to connect to the CAN-bus of the vehicle and it is equipped with the Signal Converter 11 to input and output the CAN communication signal sent by CAN-bus, also is equipped with CPU 12 which send and receive the signals with the Signal Converter 11. The CPU 12 is configured to send controlling signal to the Sound Module 20 by receiving CAN communication signals regarding to the driving environment from the above described CAN-bus, then this Sound Module 20 is configured to detects the vehicle's driving condition and generates the artificial engine sound, which substitute for the sound of gas-powered vehicle.

Further, Sound Module 20 is configured to send the sound output signal based on the control signal from the CAN Module 10 that is connected to CAN-bus, and it is equipped with the CPU21, which receives the control signals and sends the sound output signal, the D/A Translator 22 and the Amplifier 23. This Sound Module 20 is equipped with the Speaker 24 as an audio output device and it generates the required artificial engine sound corresponding to the sound output signal.

FIG. 25 is the memory media. This Memory Media 25 store the data of various kind of artificial engine sound to be output from audio output devices as Speaker 24. This makes possible to output the appropriate sound immediately corresponding to the Vehicles driving environment.

For the Memory Media 25, we can utilize memory device as the built-in Rom or IC chip of the Sound module 20, also, a removable universal type USB, SD card, mini SD card, memory stick, other memory media and IC chip can be used. When these kind of additional memory devices are used, memorizing the various sounds information can diversify the artificial engine sound.

While the above mentioned CAN-module Unit 2 is obtaining the information of the vehicle's driving environment, if the information from CAN-bus is not sufficient, an analog input jack should be established with CAN-module 10 so that necessary information can be obtained as analog signal. As examples of the analog signal, there is the signal output by the analog output jack of the vehicles or analog type electric accessories optionally equipped with the vehicle.

The CAN-module Unit should be composed to receive either the digital signal from the CAN-bus or the analog signal from aforementioned analog input jack so that it can assess the driving environment of the vehicle.

When CAN-module Unit 2 is integral structure, the wiring between the above-mentioned CAN-module 10 and the Sound Module 20 assessing the driving environment can be simple, but if the Can-module Unit 2 is isolated structure, adequate connection method such as cables or connectors can be adopted.

The above-mentioned Modules 10 and 20 can be equipped with necessary switches or medium for adjustment. For example, the ON/OFF switch, any kind of setting switch, the selector switch for the manual selection of the sound data from the Memory Media 25, the sound volume switch for the speaker 24 and so on as appropriate.

The items of the driving environments, which will be input to the said CAN-module 10 are: the rotation frequency of the engine, the velocity of the vehicle, the degree of the stamping on the accelerator, the current value between the electric motor and battery, the degree of the stepping on the brake, the ON/OFF of the headlight, the operating condition of the ignition, the position of the gearshift, the information of the vehicle's position form the GPS on board and other information necessary to each vehicle. Of course, other detected information can be input selectively as needed.

The items of analog input to the analog input part of the said CAN-module 10 is the analog signals regarding to the operation of the vehicle or attached equipment are: the On/Off of the seatbelt, the sensor of the temperature, the monitoring system of the wheels, the security device, the manual ON/OFF switch, the seated sensor, the rain drop sensor, the front and back corner sensor, which sent from the vehicle's optional electrical equipment.

With the above mentioned composition, this invention makes it possible to generate the artificial engine sound, which is suitable and reasonable to the surrounding situation, and to let pedestrian know the existence of the electric vehicle, on the other hand, the sound will not be significant noise to the other people, by selecting the category, quality and volume of the simulated sound which is emitted by the sound output devices, such as speaker 24, according to the various information from the detective devices, which is intensively input to the said Can module unit 2, for example, vehicle's speed, the rotation frequency of the electric motor, the driving speed, the degree of the stepping on the brake, the information of the vehicle's position information form the GPS on board and time information from the clock,

For example, regarding the above mentioned Artificial Sound Generator 1, it is better to be constructed so that the quality and volume of the sound can be adjusted accordingly and it is also recommended to control the sound generation depending on the information of the driving location form the navigation system; make louder the volume when driving in city centers and lower volume when driving in the suburbs.

With the Artificial Engine Sound Generator 1, which constructed as mentioned above, the sound generated by the Sound Module 20 in order to call pedestrians' attention to the vehicle, does no have to be the artificial engine sound, but it also can be the voice message.

The point is to construct the Unit to output the artificial sound by selecting the appropriate quality and adequate volume when it is necessary. The reproduced output can be programmed to be output by the input signal according to the selection set by user, or user can set up and operate the system in certain timing and to out put the required sound.

This invention is not limited to the structure of the embodiments stated above, but the shapes, structures of the each part, such as CAN-module 10, which is the component of the CAN-module Unit 2 as the artificial sound generator, the Sound Module 20 and so on, can be converted or modified accordingly.

The CAN-module Unit 2, which functions as the Artificial Engine Sound Generator of this invention, can be equipped to the vehicle as an optional parts, or can be installed in the manufacturing process of the vehicle.

The text of Japanese priority application no. 2009-211058 filed on Aug. 21, 2009 is hereby incorporated by reference.

### DESCRIPTION OF THE CODE

1. Artificial Engine Sound Generator
2. CAN-module Unit (operates as the artificial engine sound generator)
10. CAN-module
11. Signal Converter
12. CPU
20. Sound Module
21. CPU
22. D/A Translator 22
23. Amplifier
24. Speaker (audio output device)
25. Memory Media

1. An artificial engine sound generator for vehicles which uses an electric motor as a driving source, which detects a driving environment of a vehicle and emits an artificial engine sound of the vehicle;
the artificial engine sound generator comprises a CAN-bus communication port and a CAN-module unit, which can be connected with the CAN-bus communication port of the vehicle;
the CAN-module unit comprises a CAN-module, which is connected to the CAN-bus communication port of the vehicle, and a sound module, which sends a given artificial sound based on a control signal sent by the CAN-module;
the CAN-module receives a signal from various detectors, which detect a driving environment;
wherein a composition to output an artificial engine sound from an audio output device is done by controlling the audio output device.

2. The artificial engine sound generator of claim 1, wherein inputs to the CAN-module include at least one of: a rotation frequency of the engine, a velocity of the vehicle, a degree of pressing on an accelerator, an electric current between an electric motor and a battery, a degree of pressing on a brake, an ON/OFF position of a headlight, an operating condition of an ignition, and a position of a gearshift.

3. The artificial engine sound generator of claim 1, wherein the CAN-module unit includes a CAN-input part, which inputs a CAN communication signal sent from the CAN-bus communication port, and an analog input part which receives the analog signals sent by various vehicles;
wherein obtaining the control signal which is sent to the sound module by assessing the driving condition only with the received CAN communication signal or both with the CAN communication signal and the analog communication signal.

4. The artificial engine sound generator of claim 1, further comprising a CAN-input part constructed to obtain information on a start/stop condition of the engine, motion of the various sensors, velocity of the vehicle, position of a gearshift and other data from the CAN-bus communication port; and
a CAN-output part equipped with a function, which sends a direction to generate a sound to the sound module.

5. The artificial engine sound generator of claim 1, further comprising a sound module equipped with a memory medium, which stores the artificial engine sound.

6. The artificial engine sound generator of claim 5, wherein outputting the sound controlled by the signals from the CAN-module choosing the sound from various artificial sounds in the memory medium.

7. The artificial engine sound generator as defined in claim 1, further comprising a memory medium, which stores various artificial engine sounds, so that the various artificial engine sounds can be selected and input to the memory medium.
